(19) United States
(12) Patent Application Publication
(10) Pub. No.: US 2025/0185622 A1
(43) Pub. Date: Jun. 12, 2025

(54) ANIMAL HOUSING PRODUCT INCLUDING AN ENCLOSURE WITH STIMULATORY RECESS MATERIAL

(71) Applicant: The Andersons Inc., Maumee, OH (US)

(72) Inventors: Norman A. Peiffer, Maumee, OH (US); Edward L. Sharek, Maumee, OH (US)

(73) Assignee: The Andersons Inc., Maumee, OH (US)

(21) Appl. No.: 18/973,165

(22) Filed: Dec. 9, 2024

Related U.S. Application Data
(60) Provisional application No. 63/607,606, filed on Dec. 8, 2023.

(51) Int. Cl. A01K 1/035; A01K 1/03

(52) U.S. Cl. CPC A01K 1/035; A01K 1/032

(57) ABSTRACT

An animal housing product is provided that includes an enclosure with at least one point of entry. A recess having a mouth is provided, the recess positioned on a surface of the enclosure. A recess material is provided within the recess, where the recess material induces extended play time in a laboratory animal by providing the animal the opportunity to relocate the enrichment material. A process for enriching a laboratory animal in a cage includes providing the animal with the enclosure with the recess containing recess material. The animal is allowed to move the recess material from the recess via the mouth.

### RELATED APPLICATIONS

This application claims priority benefit of U.S. Provisional Application Ser. No. 63/607,606, filed Dec. 8, 2023; the contents of which are hereby incorporated by reference.

### FIELD OF THE INVENTION

The present invention in general relates to animal housing products, and in particular to enclosures that provide a degree of privacy and safety to an animal confined within a holding area; stimulative materials are provided, the manipulation of which offer an animal with a degree of mental stimulation, physical activity, and nest building material for thermoregulation, refuge, and birthing.

### BACKGROUND OF THE INVENTION

There is a growing body of evidence that domesticated animals and in particular laboratory animals exhibit behaviors that in humans are associated with sensory deprivation, and depression. These abnormal behaviors not only impact the well-being of an individual animal but also have implications in studies involving such an animal owing to the physiological effects of sensory deprivation and depression. In humans, sensory deprivation and depression have an effect on metabolism, cognitive function, immune response and other parameters relevant to clinical studies. The ability to provide a laboratory animal with a degree of mental stimulation is hampered by the requirements of study protocols that attempt to avoid introduction of new reaction variables, as well as the requirement in many instances that only sterilized materials be brought into contact with a laboratory animal. Captive animals deserve an environment which is rich in social opportunity, mental stimulation, and physical challenges. Sterility conditions are typically enforced in instances where an animal has been immunocompromised or otherwise carries a genetic defect rendering an animal vulnerable to disease or infection.

Enrichment materials provided to laboratory animals facilitate activities and purpose for the animals. Enrichment materials illustratively include toys, cardboard tunnels, cardboard enclosures, gnawing blocks, exercise equipment, litter, and nesting materials. Examples of nesting materials illustratively include aspen shavings, cotton squares, rolled paper and pellets, paper strips, and a puck formed from compressed paper strips as disclosed in U.S. Pat. No. 9,398,757; to The Andersons, Inc., and is incorporated herein by reference in its entirety. Enrichment materials encourage laboratory animals to exhibit their natural instincts to produce or seek shelter and provide the animals with a degree of control over their environment. These positive behaviors lead to improved brain and neuronal development and reduce undesirable traits and behaviors in the animals including aggressive behavior and fighting, stereotypies, and barbering. Stereotypes are repetitive movements or sounds, and in lab animals typically include simple movements such as body-rocking and head-nodding, or more complex movements, such as pacing. Barbering is defined as abnormal whisker and fur plucking behavior commonly seen in mice and is thought to be associated with an expression of social dominance.

With laboratory study requirements, there are a limited number of opportunities to provide a source of stimulation to a confined laboratory animal. Prior art attempts have been made to include folded squares of paper with the intention that the animal would occupy time delaminating and chewing or unfolding the small chips of paper. Unfortunately, such attempts met with limited success. The 1985 amendments to the Animal Welfare Act included provisions for the promotion of the psychological well-being of nonhuman primates and for exercise for dogs. Today, many research, teaching, and testing facilities have established environmental enrichment programs for all animal species. (awic.nal.usda.gov/nal_display/index) are representative of this effort.

Nest building is a natural activity of rodents, especially mice. Nest building is a form of psychological enrichment and a vital part of needs for a mouse environment. Mice tend to be most comfortable at a temperature of 30 degrees Celsius. Often laboratories housing mice are maintained at a temperature of 21 to 24 degrees Celsius. Mice build nests in order to thermoregulate. Through the maintenance of mice at a comfortable temperature, mice consume less food, have higher pup yields, and experience less overall stress.

FIGS. 1A-1C are perspective views of prior art enclosures currently available for laboratory settings. The enclosures shown are typically made of clean paper that is molded paper cellulose, and are adhesive/glue free, as well as ink and contamination free. The enclosures shown are autoclavable or use irradiation for sterilization.

While there have been many advancements in enrichment materials and improvements for the quality of living conditions for laboratory animals there continues to be a need for further efficiencies in laboratory set up for animals that also provide for improvements in the well-being of the animals, as well as, efficient distribution to animal cages and usage of materials.

Thus, there exists a need for an improved animal enclosure product that engages the attention of a laboratory animal to occupy time and alleviate some of the symptoms associated with sensory deprivation and lack of thermal regulation. There further exists a need for such an enclosure with enrichment materials that is capable of being sterilized, provides for improved efficiencies in setup times and economies of scale and still functions as an effective animal enclosure product.

### SUMMARY OF THE INVENTION

The present invention in general relates to animal housing products, and in particular to enclosures that provide a degree of privacy and safety to an animal confined within a holding area; stimulative materials are provided, the manipulation of which offer an animal with a degree of mental stimulation, physical activity, and nest building material for thermoregulation, refuge, and birthing.

An animal housing product is provided that includes an enclosure with at least one point of entry. A recess having a mouth is provided, the recess positioned on a surface of the enclosure. A recess material is provided within the recess, where the recess material induces extended play time in a laboratory animal by providing the animal the opportunity to relocate the enrichment material.

A process for enriching a laboratory animal in a cage includes providing the animal with the enclosure with the recess containing recess material. The animal is allowed to move the recess material from the recess via the mouth.

### BRIEF DESCRIPTION OF THE DRAWINGS

FIGS. 1A-1C are perspective views of prior art enclosures;

FIG. 2 is a front perspective view of an enclosure with a recess for holding nesting materials in accordance with embodiments of the invention;

FIG. 3 is a top view of the enclosure of FIG. 2;

FIG. 4 is a perspective view of paper strips used as nesting material;

FIG. 5 is a perspective view of a puck formed from compressed paper strips of FIG. 4;

FIG. 6 is a perspective view of rolled paper that form paper pellets for nesting material;

FIG. 7 is a top view of the puck of FIG. 5 inserted in the recess of the enclosure in accordance with embodiments of the invention;

FIG. 8 is a top view of an enclosure with two entrances and nesting material in the recess in accordance with embodiments of the invention;

FIGS. 9A-9D are a series of top views of enclosure shapes in accordance with embodiments of the invention;

FIG. 10 is a front, partial cutaway view of an enclosure with a partially formed entrance and a recess for holding nesting materials in accordance with certain embodiments of the invention;

FIG. 11 is a perspective view of an enclosure with paper strips placed in the recess in accordance with embodiments of the invention;

FIG. 12 is front, partial cutaway view of a polyhedral enclosure with a recess integrated into a sidewall for holding nesting materials in accordance with certain embodiments of the invention;

FIG. 13 is a coaxial nested stack of the enclosure depicted in FIG. 12; and

FIG. 14 is a perspective representation of laboratory animal manipulation of the puck within an enclosure.

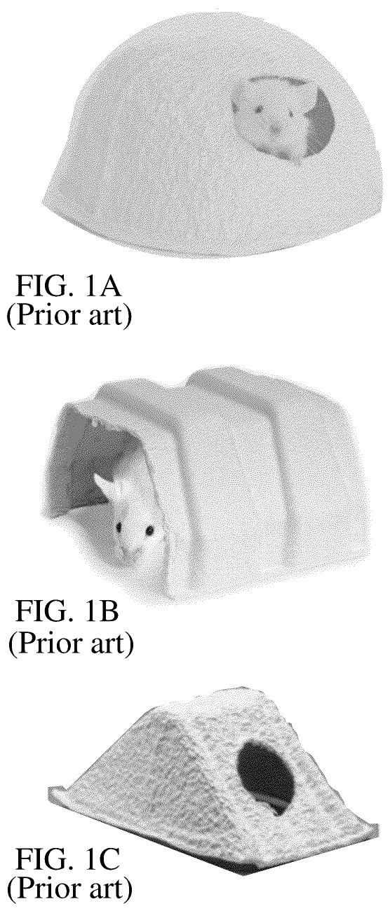

### DESCRIPTION OF THE INVENTION

The present invention has utility as an animal enclosure that incorporates a recess for nest building enrichment material. Embodiments of the animal enclosure provide privacy and a refuge for the animal and the nesting material provides thermal regulation and other benefits including activity to prevent boredom and unwanted behaviors by allowing the animal to move enrichment material into the enclosure. Pup mortality is noted to be lower in implementations of the enclosure kit, with a nearly total elimination of psychotic activity exhibited by the animals. Embodiments of the present invention that incorporate premeasured recess material in a recess allow for less labor-intensive laboratory deployments. Embodiments of an inventive animal enclosure may be made of pulped paper, which is clean paper that is molded paper cellulose, and are adhesive/glue free, as well as ink and contamination free. In a specific inventive embodiment, the enclosure is made of molded fiber pulp, chipboard, cardboard, bamboo, ferrous and non-ferrous materials, borosilicate laboratory grade glass, tempered glass, polycarbonate, acrylonitrile-butadiene-styrene copolymer, polyethylene, polypropylene, polyvinylchloride, or other plastic materials. It is appreciated that some of the materials support cleaning and reusage, while others of the aforementioned list are known the art as being well-suited for gnawing, with resulting stimulation and discard after usage. The molded fiber pulp enclosure is recyclable and may be composted. The plastic-based enclosure and non-paper materials may be reused following proper sterilization. The enclosures are autoclavable or use irradiation for sterilization. Irradiation may be conducted with a cobalt-60 source. In still other inventive embodiments, an enclosure with premeasured recess material define a shape that is amenable to coaxially fitting with other enclosures to form a nested stack.

Recess material used in embodiments of the invention illustratively include paper strips, rolled paper strips, materials that form pellets, a puck, or an amorphous mass. The recess material in some embodiments is amenable to usage as a nesting material and is illustratively formed from compressed paper strips, cellulosic fluff, cotton fiber, crinkle paper, wood strips, wood chips, and shavings; natural materials such as cotton nestlets, or combinations thereof. It is observed that the unfolding or other manipulation of the recess material provides an animal with a degree of mental stimulation and nest construction. It has been surprisingly found that a compressed mass provides multiple benefits to the animal including mental stimulation and activity generation, nesting material, and also improved temperature regulation. Additionally, the pre-measured quantum of material in an inventive product affords a benefit to the caregiver in that the product is simply placed in the cage without resort to measuring and thereby saving time and precluding spillage of separated materials. With the animal occupied and thermally regulated, it is noted that animal food consumption and health are generally improved. The present invention is particularly beneficial to rodents and especially mice. In still other embodiments, food is the recess material, alone or in combination with nesting material. It has been observed that burrowing into the recess material to find foodstuffs also affords a caged animal a degree of mental stimulation and activity that is lacking in a conventional feeding tray.

The deconstruction of the recess material by an animal into constituent components provides the animal with an activity that occupies time and appears to alleviate behaviors associated with cage confinement. Recess materials illustratively include paper strip material, wood cotton, bamboo, and other cellulosics. It is appreciated that the components of an inventive enclosure and nesting material are amenable to sterilization in some inventive embodiments. The resultant decompressed strips are routinely fashioned into nesting material by animals. In addition, the animal is able to push or carry the recess material into the enclosure from the recess. In some inventive embodiments, an enclosure includes a first opening through the animal may pass with only less than all of the recess material. Such a reduced opening has a diameter of no more than 20% of maximal cross section of the animal. In still other inventive embodiments, a second opening is provided in the enclosure. The second opening is readily placed along the base or intermediate in position between the recess and the base. A second opening affords for ventilation within the enclosure and provides a potential situs for discardable material enclosure gnawing by the animal. In an instance where more than quantum of recess material is introduced to the animal's environment, the animal can collect the quantum or distribute the deconstructed components thereof around their cage, as well as into the enclosure.

As used herein, the term “strip” is defined to include at least one ply of fibrous material. The fibrous material illustratively includes cellulose, alkoxylated cellulose, alginate, starch, polyethylene, polypropylene, polyvinyl, polystyrene, Spandex, Lycra, rubber, fleece, cellulose pulp, cellulose pulp derivatives, or any combinations thereof. The strips being planar, crinkled, twisted, rolls, and combinations thereof.

As used herein, an “animal” is defined to include a rodent such as a mouse, rat, hamster, gerbil, and rabbit; a bird such as a quail, chicken, turkey, parrot, parakeet, canary, and finch: felines, such as domesticated cats; and a primate such as a monkey, chimpanzee, and gorilla.

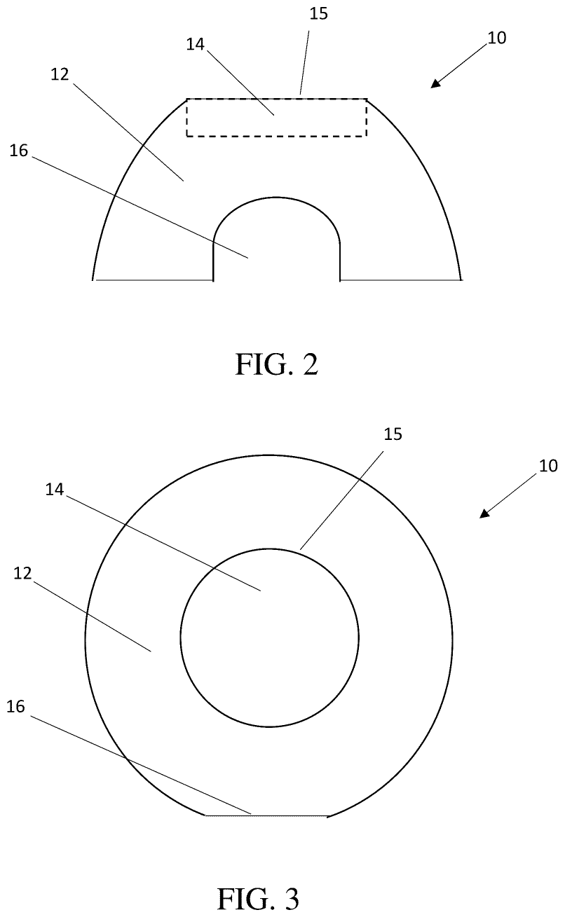

Referring now to the figures, FIG. 2 is a front perspective view of an embodiment of an inventive enclosure 10 with walls 12 and a recess 14 for recess materials. An entrance opening 16 provides an entry point for the animal, while the walls 12 provide a degree of privacy to the animal and the enclosure 10 retains body heat generated by the animal. It is appreciated that the inventive enclosure 10 is amenable to stacking for efficient packing and shipping. In other inventive embodiments, an inventive enclosure has a polygonal shape that illustratively includes trigonal pyramidal, quadrilateral pyramidal, recessed hemispherical, conical, conical, partial dodecahedral, partial icosahedral; and truncated forms thereof. In some embodiments, the truncation forms a top surface into which a recess is formed. In other embodiments, the recess is in a sidewall of the enclosure, independent of whether the recess has a mouth accessed from the exterior or interior volume of the enclosure.

FIG. 3 is a top view of an enclosure 10 of FIG. 2 that more clearly shows recess 14 placed at the top of enclosure 10 access through the mouth 15. It is appreciated that the recess may be placed elsewhere along walls 12 of enclosure 10. In instances where the recess 14 is on a vertical surface of the wall 12, the enrichment nesting materials may be placed there in a pouch.

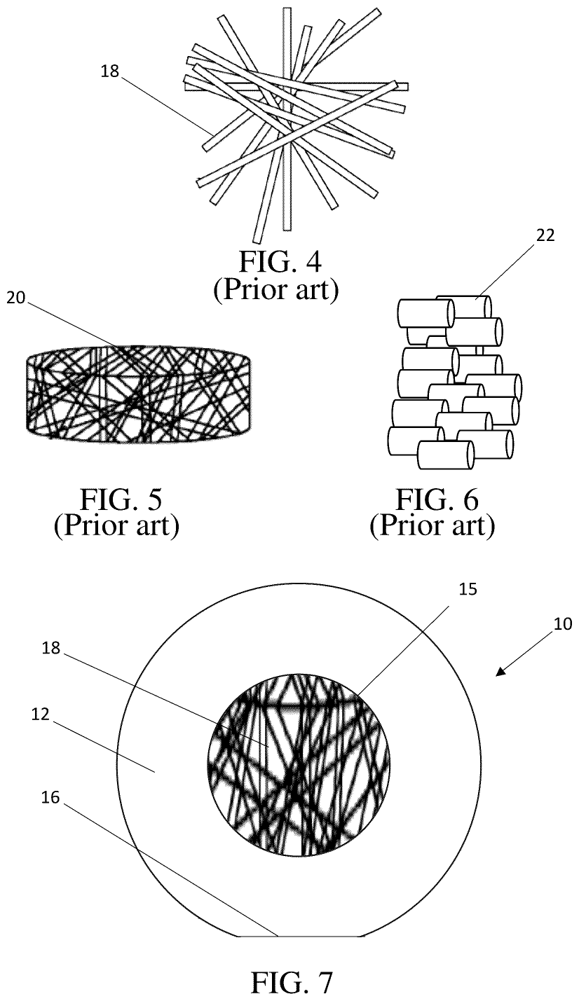

FIG. 4 illustrates a group or pile of recess materials depicted as strips 18 that may be provided loose as nesting material, or that are compressed to form the puck 20 as depicted in FIG. 5, and as disclosed in U.S. Pat. No. 9,398,757. The paper strips 18 may have a height to length ratio from 1:1 to 1:200; and in still other embodiments from 1:5 to 1:50 with the understanding that other height to length ratios depending on the overall dimensions of the puck 20 are operative herein. It is appreciated that the term “puck” includes shapes other than right cylinders and also include rectilinear forms, spheroids, polygonal forms, and geometrically irregular forms. The puck can have smooth or frayed edges. The thickness of the paper strips 18 may typically be between 0.07 millimeters (0.0028 in) and 0.18 millimeters (0.0071 in). It is also appreciated that according to the present invention, depending on the size of the animal, the thickness of the paper strip 18 is increased beyond these values.

The recess material 18 are in certain embodiments amenable to sterilization for use in conjunction with immuno-compromised or genetically mutated laboratory animal models for disease. The sterilization techniques operative with the paper strip component of a puck 20 illustratively include gamma radiation, including from a cobalt-60 source and thermal sterilization techniques such as those involving superheated steam or heated air.

The recess material 18 amenable to incorporation of various adjuvants operative to enhance performance and/or entertainment value of the puck 20. Adjuvants suitably incorporated into the recess material 18 illustratively include fragrances; dyes; odor suppressants such as baking soda; superabsorbent polymer granules; flavorants such as sugar and fruit flavors; and nutrients. In the instance where a recess material 18 component includes entertainment value enhancing adjuvants such as dyes or flavorants, it is appreciated that the stimulation value is enhanced by irregular distribution of the adjuvant. Irregular distribution is readily achieved by exposing the pile of recess material 18 for an amount of time sufficient to create an incomplete penetration of the adjuvant into the recess material 18. It is appreciated that an adjuvant is readily applied in the form of a solid, liquid, or solution with excess moisture being removed to arrive at a paper strip 18 component moisture component with a preselected level.

The puck 20 is formed by compressing a pile of recess material 18 in a mold. As shown in FIG. 4, the pile of recess material 18 is composed of a randomized material, which when compressed form the puck 20. To aid in the forming and retention of the puck shape during and after the release from the mold, the recess material 18 may be wetted with water or other alternative liquids.

In certain inventive embodiments, the puck 20 is sized relative to the diameter of the recess 14 of the enclosure 10. By way of example, for housing mice, a puck 20 has a mean height between 25.4 millimeters (0.1 in) and 254 millimeters (1.0 in). The diameter of the puck 20 may vary in accordance with the size of the recess 14, for example between 127 millimeters (0.5 in) and 508 millimeters (2.0 in), with a typical ratio between diameter and height of between 2:1 and 30:1. It is appreciated that the mean height and diameter of the puck 20 is chosen with recognition as to the size and dexterity of the animal using the inventive puck 20, as well as the dimensions of the recess 14 and enclosure 10. In still other embodiments, the puck 20 is sized to not be conveyed as an intact article through the recess 14 to promote animal stimulation. For example, much larger dimensions would be required for a puck for use with larger mammals than rodents.

FIG. 6 is a perspective view of rolled paper that form paper pellets 22 for nesting material that may be used in conjunction with the enclosure 10.

FIG. 7 is a top view of puck 20 inserted in the recess 14 of the enclosure 10. An animal, when provided with the puck 20, engages in an activity to reduce boredom, anxiety, and stress; as well experiencing enhanced mental stimulation. An animal is also noted to have better thermal regulation upon deconstruction of a puck 20 into constituent strips of recess material 18 and therefore have lower overall food consumption. The activity involves relocation of one or more supplied pucks 20 and systematic turning and unfolding of the pucks 20 to yield individual paper strips or recess material 18. Typically, an animal moves a puck 20 from the recess 14 via the opening 15 to the interior of the enclosure 10, as well as additional pucks 20 to additional locations within the cage.

An animal exposed to a puck 20, in particular a rodent, is observed to initially begin chewing the puck 20. Upon the animal discovering that the puck 20 begins to unravel into strips of paper 18, animal handling and chewing of a puck 20 becomes purposeful with the intent of rendering a puck 20 as a collection of paper strips 18. The paper strips 18 formed from unfolding the one or more pucks 20 are then taken by the animal to be used to form a hiding place as well as bedding, especially within enclosure 10.

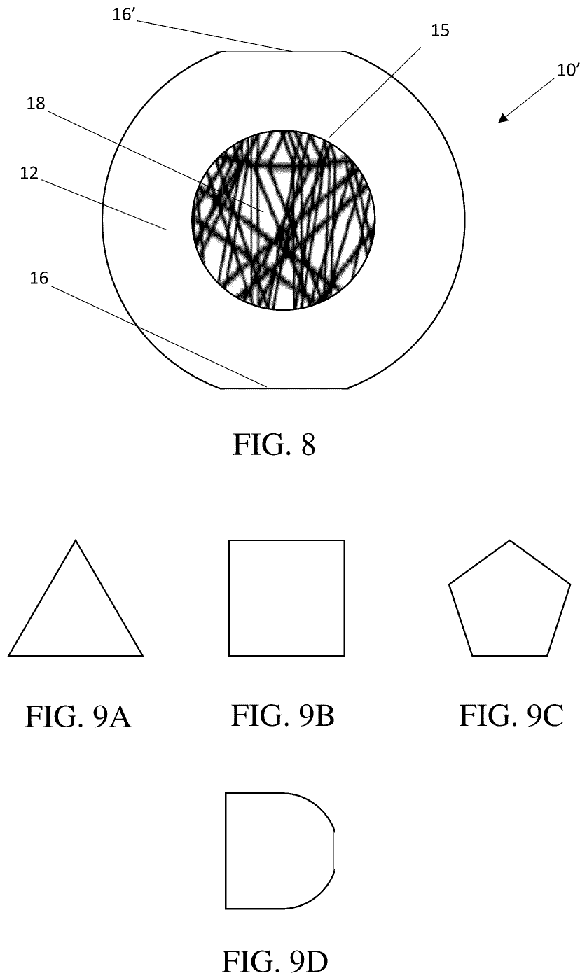

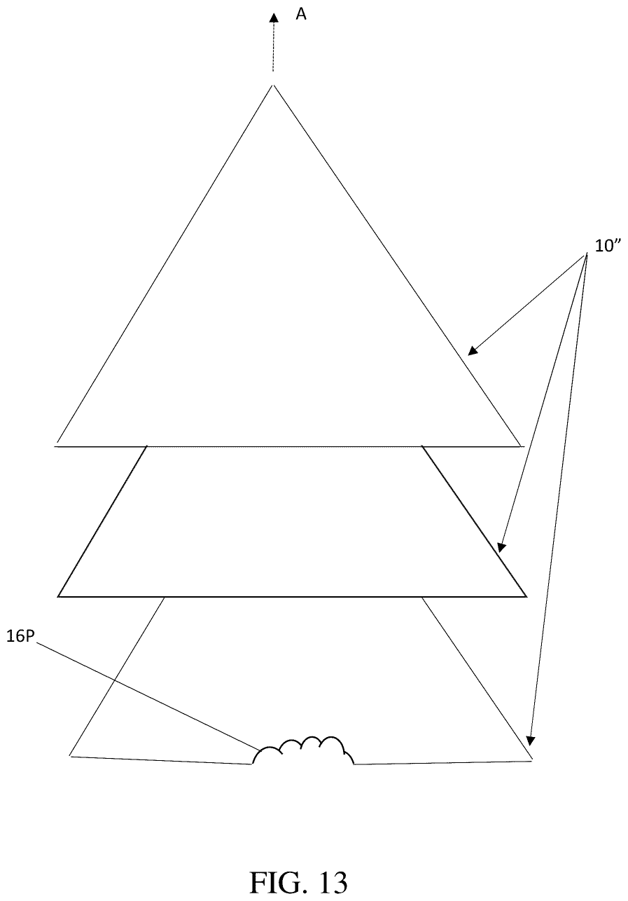

FIG. 8 is a top view of an enclosure 10′ with two openings (16, 16′) and recess material 18 in recess 14 in which like reference numeral have the meanings ascribed thereto with respect to the aforementioned drawings. While depicted with two openings (16, 16′), it is appreciated that additional openings are readily provided. Additional openings can promote animal stimulation as well as ventilation of the enclosure interior. The addition of additional entranceways may provide an animal with play opportunities. It is appreciated that while example embodiments of the enclosure have been shown as spherical, other shapes may also be used to form an enclosure illustratively including in top views trigonal pyramidal or conical (FIG. 9A), quadrangular pyramidal (FIG. 9B), pentagonal pyramidal (FIG. 9C), and a shape where one wall is removed (FIG. 9D). The removal of a wall as shown in FIG. 9D allows for placement along an observation window of a cage. It is appreciated that by adding a taper from the base to apex of a given inventive enclosure, multiple enclosures are amenable to coaxial positioning to form a nested stack. An example of a nested stack being depicted in FIG. 13.

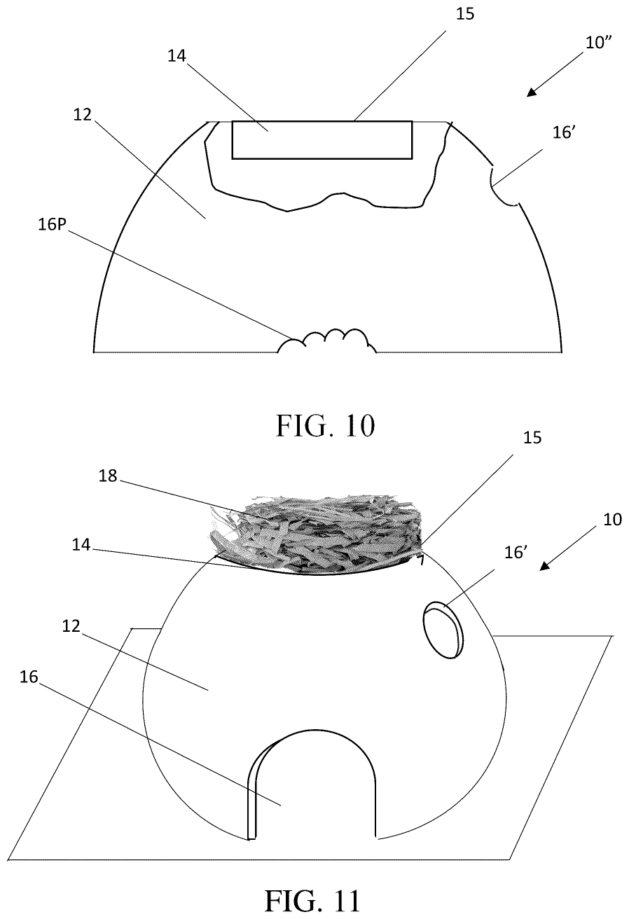

FIG. 10 is a front, partial cutaway view of an enclosure 10″ with a partially formed entrance 16P and a recess 14 for holding nesting materials in which like reference numeral have the meanings ascribed thereto with respect to the aforementioned drawings. The partially formed entrance 16P may look more natural to the animal and encourage the animal to gnaw at the partial entrance 16P to widen the entrance to achieve access to the interior of the enclosure. The additional activity may provide the animal with an additional feeling of control of their situation.

FIG. 11 is a perspective view of enclosure 10 with recess material 18 placed in the recess.

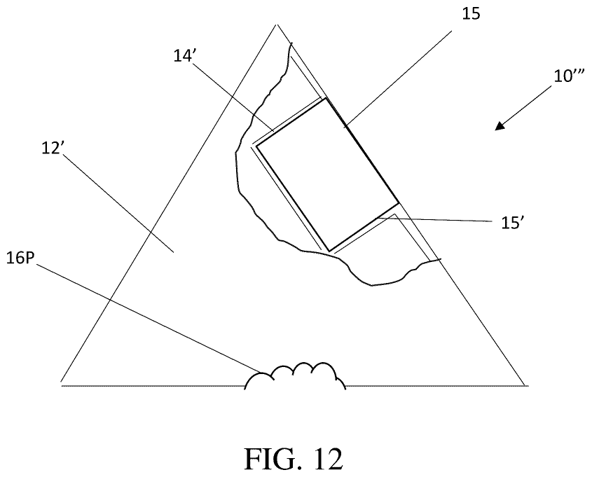

FIG. 12 is a front, partial cutaway view of an enclosure 10′″ with a partially formed entrance 16P and a planar side wall 12′ having at least one recess 14′ for holding nesting materials, in which like reference numeral have the meanings ascribed thereto with respect to the aforementioned drawings. The recess 14′ has the mouth 15 accessed from the exterior or the mouth 15′ that is accessed from interior volume of the enclosure 10′″.

FIG. 13 depicts multiple enclosures 10′″ coaxially positioning to form a nested stack. The uppermost and intermediate enclosures 10″ are rotated relative to the common axis A such that the opening 16 is not seen therein.

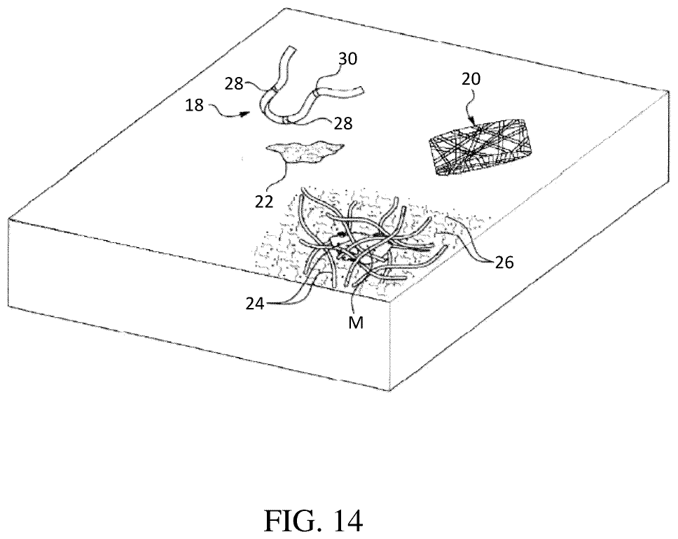

As shown with reference to FIG. 14, the inventive puck 20 as provided to an animal contains recess material 18. An animal, such as a mouse M, as depicted in FIG. 3, begins to interact with the inventive puck 20 or recess material 18. The animal M chews thus produces a macerated polymeric mass 22. Typically, the animal M begins to unravel pucks to form partially unraveled paper strips from the puck 20 or recess material 18, and eventually succeeds in creating only unraveled recess material 1818. The recess material 18, partially unraveled puck 20 and macerated mass 22 in varying amounts are formed as a shelter 24 and/or a bedding mass 26. A surprising aspect of the present invention is that male rodents, which are more likely to exhibit abhorrent and antisocial behavior, are also observed to engage in apparent play behavior with the recess material 18 of a puck 20. The periodic inclusion of flavorant patches 28 and to a lesser extent colorimetric zones 30 along the length of a paper strip 12 is noted to enhance animal interest in the inventive puck.

The present invention is further illustrated through resort to the following non-limiting examples. These examples are not intended to limit the scope of the appended claims.

### EXAMPLES

### Example 1—A Cage with an Enclosure Per FIG. 11 with Recess Material Furnished in a Recess of the Enclosure with an Animal Litter for a Base Material Versus a Cage with Only the Animal Litter

A total of ten separate cages with five of the cages configured with only animal litter, and the other five cages configured with an enclosure with a recess material furnished in a recess per FIG. 11. All cages are structurally identical and kept in isolation. To each cage, a male mouse with comparable weight, age, and physiological conditions is placed.

The following experimental parameters are examined: the first play period before the first resting observed; the length of the first resting segment; the second play period between the first two resting segments; and the length of the second resting segment. Table 1 illustrates the results of the experiment. The term “play period” refers to a period of time in minutes during which a rodent is relatively continuously touching, kicking, rolling, and dissecting the recess material. The term “resting segment” refers to a period of time during which a rodent is in an idling position such as lying down, sitting, or merely walking. Each time period is presented as an average of five independent readings. Table 1 shows the relevant results with regard to this experiment.

TABLE 1

| | Average for | Average for |
|---|---|---|
| | Comparative Group | Inventive Group |
| First period | 7 minutes | 21 minutes |
| First resting segment | 6 minutes | 5 minutes |
| Second play period | 5 minutes | 32 minutes |
| Second resting segment | 9 minutes | 7 minutes |

The substantial prolongation in playing times associated with the inventive enclosure with a puck is due to the following factors. The rodents in the inventive group first spend a portion of time in moving the puck in the cage. After the relocation of the recess material is done, the rodent starts deconstructing the recess material to form bedding or a nest within the enclosure. Rodents in the comparative group lack the stimulation provided by the recess material.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. An animal housing product, said product comprising:
an enclosure with at least one point of entry;
a recess having a mouth, the recess positioned on a surface of the enclosure; and
a recess material within the recess, where the recess material induces extended play time in a laboratory animal by providing the animal the opportunity to relocate the enrichment material.

2. The animal housing product of claim 1 wherein the enclosure is formed of pulped paper.

3. The animal housing product of claim 1 wherein the enclosure is formed of chipboard, cardboard, bamboo, ferrous and non-ferrous materials, borosilicate laboratory grade glass, tempered glass, polycarbonate, acrylonitrile-butadiene-styrene copolymer, polyethylene, polypropylene, polyvinylchloride.

4. The animal housing product of claim 1 wherein the enclosure is adapted to be coaxially stackable.

5. The animal housing product of claim 1 wherein the enclosure is adapted to be sterilized.

6. The animal housing product of claim 1 wherein the enclosure has a shape of trigonal pyramidal, quadrilateral pyramidal, recessed hemispherical, conical, conical, partial dodecahedral, partial icosahedral; and truncated forms thereof.

7. The animal housing product of claim 1 wherein the recess is compressed paper strips, cellulosic fluff, cotton fiber, crinkle paper, wood strips, wood chips, and shavings; natural materials such as cotton nestlets, or combinations thereof, or a combination thereof.

8. The animal housing product of claim 7 wherein said plurality of paper strips are present and comprise at least one ply of fibrous material.

9. The animal housing product of claim 8 wherein the fibrous material includes cellulose, alkoxylated cellulose, alginate, starch, polyethylene, polypropylene, polyvinyl, polystyrene, Spandex, Lycra, rubber, fleece, cellulose pulp, cellulose derivatives, or any combinations thereof.

10. The animal housing product of claim 7 wherein the plurality of paper strips are present and have a height to length ratio from about 1:1 to about 1:200; and
wherein the plurality of paper strips has a thickness between 0.07 millimeters (0.0028 in) and 0.18 millimeters (0.0071 in).

11. The animal housing product of claim 1 wherein the recess material further comprises fragrances, dyes, odor suppressants, superabsorbent polymer granules, and flavorants.

12. The animal housing product of claim 1 wherein the at least one point of entry is only partially formed and is continuous with an open bottom.

13. The animal housing product of claim 1 wherein the recess has a shape that is circular, oval, triangular, rectangular, pentagon, hexagonal, heptagonal, octagonal, or irregular.

14. The animal housing product of claim 1 wherein the surface is a top or side of the enclosure and the mouth is accessible from an exterior of the enclosure.

15. The animal housing product of claim 1 wherein the mouth is accessible from an interior of the enclosure.

16. A process for enriching a laboratory animal in a cage comprising:
providing the animal with the enclosure with the recess containing recess material according to claim 1; and
allowing the animal to move the recess material from the recess via the mouth.

17. The process of claim 16 further comprising sterilizing the enclosure prior to placement in the cage, sterilizing the recess material prior to placement in the cage, or sterilizing both simultaneously.

18. The process of claim 17 wherein the enclosure and the recess material are in contact during the sterilizing.

19. The process of claim 16 wherein the providing of the enclosure comprises removing the enclosure from a coaxial stack containing the enclosure for inclusion in the cage.

20. The process of claim 19 further comprising removing a second enclosure from the coaxial stack for insertion into a second cage.
